(19) United States
(12) Patent Application Publication
(10) Pub. No.: US 2013/0302166 A1
(43) Pub. Date: Nov. 14, 2013

(54) TURBINE BLADE WITH CHAMFERED SQUEALER TIP FORMED FROM MULTIPLE COMPONENTS AND CONVECTIVE COOLING HOLES

(71) Applicants: CHING-PANG LEE, Cincinnati, OH (US); Mrinal Munshi, Orlando, FL (US)

(72) Inventors: CHING-PANG LEE, Cincinnati, OH (US); Mrinal Munshi, Orlando, FL (US)

(21) Appl. No.: 13/467,112

(22) Filed: May 9, 2012

(51) Int. Cl. F01D 5/08; B23K 31/02

(52) U.S. Cl. 416/95; 228/119

(57) ABSTRACT

A squealer tip usable in repair systems and formed from a pressure side outer weld rib and a suction side outer weld rib extending radially outward from a tip of the turbine blade and resting upon pressure side and suction side weld members separated by a mid-chord member is disclosed. The pressure and suction side outer weld ribs may be positioned along the pressure side and the suction side of the turbine blade, respectively. The pressure side outer weld rib may include a chamfered pressure side with film cooling holes having exhaust outlets positioned therein. The pressure and suction side weld members may be configured to retain the mid-chord member in position with over extending side surfaces.

### FIELD OF THE INVENTION

This invention is directed generally to turbine blades, and more particularly to airfoil tips for turbine blades.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures.

Typically, turbine blade is formed from a root portion at one end and an elongated portion forming a blade that extends outwardly from a platform coupled to the root portion at an opposite end of the turbine blade. The blade is ordinarily composed of a tip opposite the root section, a leading edge, and a trailing edge. The tip of a turbine blade often has a tip feature to reduce the size of the gap between ring segments and blades in the gas path of the turbine to prevent tip flow leakage, which reduces the amount of torque generated by the turbine blades. The tip features are often referred to as squealer tips and are frequently incorporated onto the tips of blades to help reduce aerodynamic losses in turbine stages. These features are designed to minimize the leakage between the blade tip and the ring segment.

### SUMMARY OF THE INVENTION

A squealer tip usable in repair systems and formed from a pressure side outer weld rib and a suction side outer weld rib extending radially outward from a tip of a turbine blade and resting upon pressure side and suction side weld members separated by a mid-chord member is disclosed. The pressure and suction side outer weld ribs may be positioned along the pressure side and the suction side of the turbine blade, respectively. The pressure side outer weld rib may include a chamfered pressure side with pressure side film cooling holes having exhaust outlets positioned therein. The pressure side film cooling holes may be configured to be diffusion cooling holes with one or more tapered sections for reducing the velocity of cooling fluids, increasing the convective surfaces, thereby increasing the efficiency of the cooling system. The pressure and suction side weld members may be configured to retain the mid-chord member in position with over extending side surfaces.

The turbine blade may be formed from a generally elongated blade having a leading edge, a trailing edge, a tip at a first end, a root coupled to the blade at a second end generally opposite the first end for supporting the blade and for coupling the blade to a disc, and an internal cooling system formed from at least one cavity positioned within the generally elongated blade. The squealer tip may be formed from a first tip cap member and a second tip cap member. The second tip cap member may be formed from a pressure side weld member and a suction side weld member, and the first tip cap member may be formed from a mid-chord member positioned between the pressure and suction side weld members. The mid-chord member may include an upstream contact surface that is nonorthogonal and nonparallel with a longitudinal axis of the generally elongated blade such that an innermost corner of the upstream contact surface extends further upstream than an outermost corner of the upstream contact surface and may include a downstream contact surface that is nonorthogonal and nonparallel with the longitudinal axis of the generally elongated blade such that an innermost corner of the downstream contact surface extends further downstream than an outermost corner of the downstream contact surface. The pressure side weld member may have a downstream contact surface that is nonorthogonal and nonparallel with the longitudinal axis of the generally elongated blade such that an outermost corner of downstream contact surface extends further downstream than an innermost corner of the downstream contact surface. The suction side weld member may have an upstream contact surface that is nonorthogonal and nonparallel with the longitudinal axis of the generally elongated blade such that an outermost corner of upstream contact surface extends further upstream than an innermost corner of the upstream contact surface. The mid-chord member may be welded on innermost corners to the generally elongated blade.

The pressure side outer weld rib may extend radially outward from the pressure side weld member such that the pressure side outer weld rib extends radially outward further than an outer surface of the suction side weld member. The pressure side outer weld rib may have a chamfered pressure side surface such that an outermost corner of the pressure side is positioned downstream from all other aspects of the pressure side surface of the pressure side outer weld rib. The chamfered pressure side surface may extend over an entire upstream side of the pressure side outer weld rib. The pressure side outer weld rib may be formed from a first material, and the pressure side weld member, the suction side weld member and the mid-chord member may be formed from a second material that is different from the first material. The pressure side outer weld rib may have an outer side surface that is aligned with an outer surface of the generally elongated blade forming a pressure side.

One or more pressure side film cooling holes may be positioned in the pressure side outer weld rib with an outlet in the chamfered pressure side surface in the pressure side outer weld rib and an inlet that couples the at least one pressure side film cooling hole with the cavity forming the internal cooling system. One or more mid-chord film cooling holes may be positioned in the mid-chord member with an outlet in an outer surface of the mid-chord member and an inlet that couples the at least one mid-chord film cooling hole with the at least one cavity forming the internal cooling system.

A suction side outer weld rib may extend radially outward from the suction side weld member such that the suction side outer weld rib extends radially outward further than an outer surface of the pressure side weld member. The suction side outer weld rib may have an outer side surface that is aligned with an outer surface of the generally elongated blade forming a suction side. The suction side outer weld rib may be formed from a first material, and the pressure side weld member, the suction side weld member and the mid-chord member may be formed from a second material that is different from the first material. A thermal barrier coating may be included on outer surfaces forming pressure and suction sides of the generally elongated blade and on outer surfaces of the pressure side weld member, the suction side weld member and the mid-chord member.

Turbine blades may be repaired by reworking the tip. In particular, a method of repairing a turbine blade may include preparing the tip of a blade by removing existing tip structure on the generally elongated blade. The tip may be prepared by grinding the surface flat. The existing tip structure may be removed by grinding or other appropriate method. A pre-weld overage heat treatment may be applied before the mid-chord member is placed on the tip. A squealer tip may be formed by positioning a mid-chord member on the tip covering the cavity forming the internal cooling system. The mid-chord member may be held in place by welding the mid-chord member on the blade tip.

A pressure side weld member may be formed on an upstream side of the mid-chord member and a suction side weld member on a downstream side of the mid-chord member by welding. In at least one embodiment, the radially outer surfaces of the pressure side weld member and suction side weld member may be ground flush with a radially outer surface of the mid-chord member.

A pressure side outer weld rib extending radially outward from the pressure side weld member may be formed. The pressure side outer weld rib may extend radially outward further than an outer surface of the suction side weld member. The pressure side outer weld rib may be formed by a weld buildup of material. A suction side outer weld rib may be formed that extends radially outward from the suction side weld member. The suction side outer weld rib may extend radially outward further than an outer surface of the pressure side weld member. The suction side outer weld rib may be formed by a weld buildup of material. A chamfered pressure side surface may be formed on the pressure side outer weld rib such that an outermost corner of the pressure side is positioned downstream from all other aspects of the pressure side surface of the pressure side outer weld rib.

The method may also include applying a thermal barrier coating on the outer surfaces forming pressure and suction sides of the generally elongated blade and on outer surfaces of the pressure side weld member, the suction side weld member and the mid-chord member. One or more pressure side film cooling holes may be established in the pressure side outer weld rib as described above through the thermal barrier coating via drilling or other appropriate method. One or more mid-chord film cooling holes may be established in the mid-chord member as described above through the thermal barrier coating via drilling or other appropriate method.

An advantage of this invention is that blades usable within turbine engines may be repaired with a squealer tip configured as described herein, thereby improving the operability of the blade when reinstalled in a gas turbine engine.

Another advantage of this invention is that squealer tip with the different materials forming the pressure and suction side outer weld ribs from the pressure and suction side weld members, the chamfered surface, the configuration of convective cooling holes realizes an increase in performance compared with blades with squealer tips without these elements.

Yet another advantage of this invention is that the tapered section of the compound angle diffuser film cooling hole increases the convection cooling surface and cooling coverage inside the squealer tip.

Another advantage of this invention is that the squealer tip has more reliable convective cooling in the squealer tip for better blade tip life and therefore lower tip leakage flow.

Still another advantage of this invention is that the chamfered surface enables cooling holes to be positioned on the surface at hot spots and for the cooling holes to have longer lengths for better cooling.

Another advantage of this invention is that the cooling holes also provide exit film cooling at the chamfered surface, thereby reducing the temperature of the airfoil at a location that is typically a hot spot, which is an area of material having an increased temperature.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a turbine blade with a squealer tip.

FIG. 2 is a detailed view of the squealer tip at the leading edge of the turbine blade shown in FIG. 1.

FIG. 3 is top view of the squealer tip shown in FIG. 1.

FIG. 4 is a partial cross-sectional view of the turbine blade tip taken at section line 4-4 in FIG. 1.

FIG. 5 is a detail front view of a compound angle diffuser film cooling hole positioned within the pressure side rib.

FIG. 6 is a detail top view of a compound angle diffuser film cooling hole positioned within the pressure side rib.

FIG. 7 is an alternative view of the leading edge of the squealer tip of the turbine blade.

FIG. 8 is a partial cross-sectional view of a turbine blade tip taken at section line 4-4 in FIG. 1 with the squealer tip removed and prepared for installation of a squealer tip.

FIG. 9 is a partial cross-sectional view of the turbine blade tip shown in FIG. 8 with a mid-chord member installed between pressure and suction side weld members.

FIG. 10 is a partial cross-sectional view of the turbine blade tip shown in FIG. 9 with pressure and suction side outer weld ribs installed on pressure and suction side weld members, respectively.

FIG. 11 is a partial cross-sectional view of the turbine blade tip shown in FIG. 10 with a chamfered upstream, pressure side surface of the pressure side weld member.

FIG. 12 is a partial cross-sectional view of the turbine blade tip shown in FIG. 11 with film cooling holes installed in the pressure side weld member and the mid-chord member and with a thermal barrier coating.

### DETAILED DESCRIPTION OF THE INVENTION

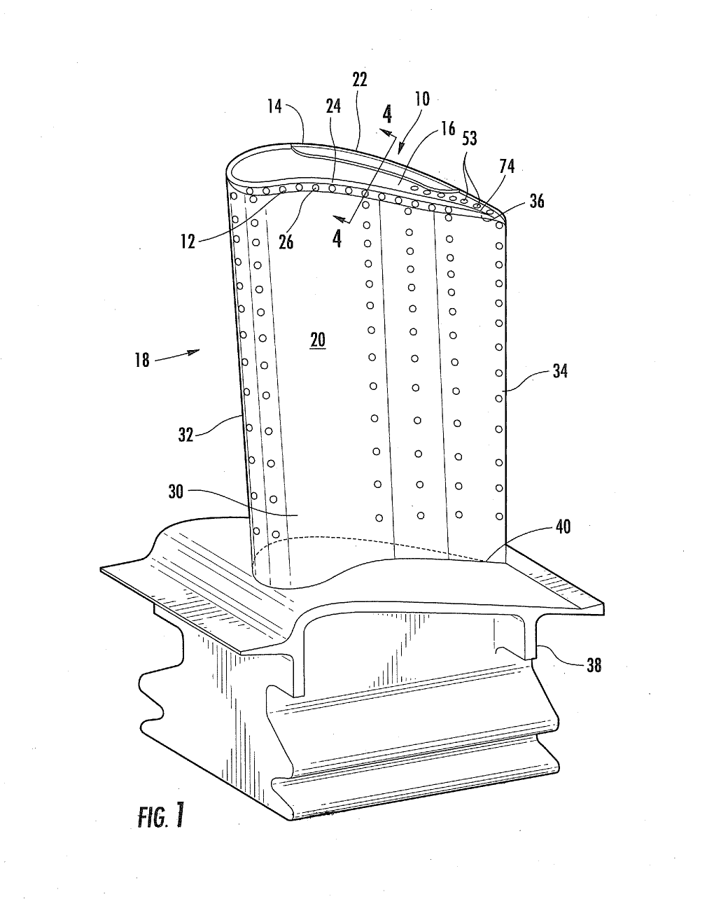

As shown in FIGS. 1-12, a squealer tip 10 usable in repair systems and formed from a pressure side outer weld rib 12 and a suction side outer weld rib 14 extending radially outward from a tip 16 of a turbine blade 18 and resting upon pressure side and suction side weld members 17, 19 separated by a mid-chord member 21 is disclosed. The pressure and suction side outer weld ribs 12, 14 may be positioned along the pressure side and the suction side 20, 22 of the turbine blade 18, respectively. The pressure side outer weld rib 12 may include a chamfered pressure side 24 with pressure side film cooling holes 26 having exhaust outlets 28 positioned therein. The pressure side film cooling holes 26 may be configured to be diffusion cooling holes with one or more tapered sections 56 for reducing the velocity of cooling fluids, increasing the convective surfaces, thereby increasing the efficiency of the cooling system. The pressure and suction side weld members 17, 19 may be configured to retain the mid-chord member 21 in position with over extending side surfaces 23.

As shown in FIG. 1, the turbine blade 18 may be formed from a generally elongated blade 30 having a leading edge 32 and a trailing edge 34. The generally elongated blade 30 may include the tip 16 at a first end 36 and a root 38 coupled to the blade 30 at a second end 40 generally opposite the first end 36 for supporting the blade 18 and for coupling the blade 18 to a disc. An internal cooling system 42 may be formed from at least one cavity 44 positioned within the generally elongated blade 30. The cooling system 42 may have any appropriate configuration to cool the turbine blade 18 during use in an operating gas turbine engine. The turbine blade 18 and its related components listed above may be formed from any appropriate material already known in the art or yet to be discovered or identified.

As shown in FIGS. 11 and 12, the squealer tip 10 may be formed from a first tip cap member 11 and a second tip cap member 13. The second tip cap member 13 may be formed from the pressure side weld member 17 and a suction side weld member 19. The first tip cap member 11 may be formed from a mid-chord member 21 positioned between the pressure and suction side weld members 17, 19. The mid-chord member 21 may include a tapered upstream contact surface 25 that is nonorthogonal and nonparallel with a longitudinal axis 27 of the generally elongated blade 30 such that an innermost corner 29 of the upstream contact surface 25 extends further upstream than an outermost corner 31 of the upstream contact surface 25 and includes a downstream contact surface 33 that is nonorthogonal and nonparallel with the longitudinal axis 27 of the generally elongated blade 30 such that an innermost corner 35 of the downstream contact surface 33 extends further downstream than an outermost corner 37 of the downstream contact surface 33. The mid-chord member may be welded on innermost corners 29, 35 to the generally elongated blade 30 with materials, such as, but not limited to, IN 625 and Hastalloy W as a ductile filer.

The pressure side weld member 17 may be formed in place around of the mid-chord member 21 between the pressure side 20 and the mid-chord member 21. For instance, in at least one embodiment, the pressure side weld member 17 may be formed as a weld from materials, such as, but not limited to, IN 738. The pressure side weld member 17 may have a downstream contact surface 39 that is nonorthogonal and nonparallel with the longitudinal axis 27 of the generally elongated blade 30 such that an outermost corner 41 of the downstream contact surface 39 extends further downstream than an innermost corner 43 of the downstream contact surface 39.

Similarly, the suction side weld member 19 may be formed in place around of the mid-chord member 21 between the suction side 22 and the mid-chord member 21. For instance, in at least one embodiment, the suction side weld member 19 may be formed as a weld from materials, such as, but not limited to, IN 738. The suction side weld member 19 may have an upstream contact surface 45 that is nonorthogonal and nonparallel with the longitudinal axis 27 of the generally elongated blade 30 such that an outermost corner 47 of upstream contact surface 45 extends further upstream than an innermost corner 49 of the upstream contact surface 45.

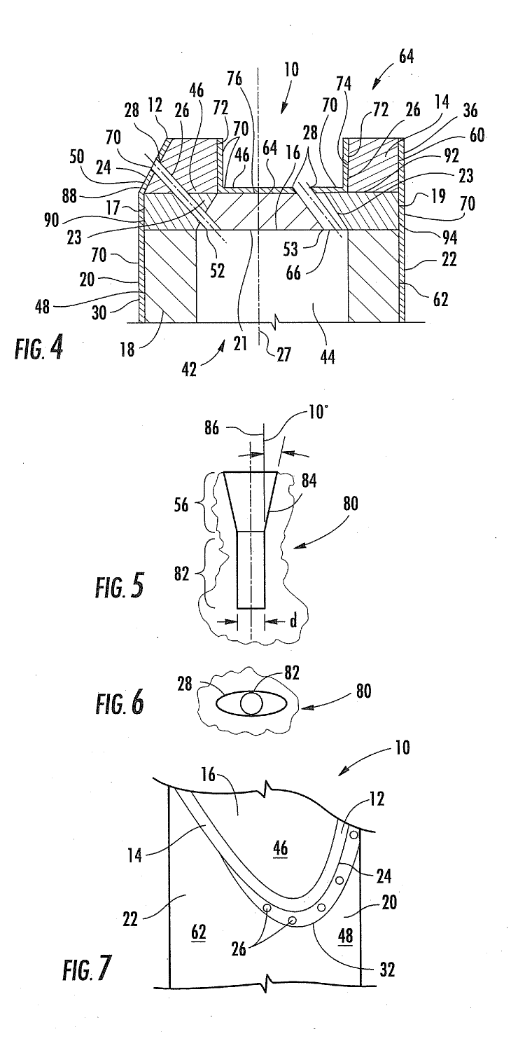

The pressure side outer weld rib 12 may extend radially from an outer surface 46 of the pressure side weld member 17. In one embodiment, the pressure side outer weld rib 12 may extend from the leading edge 32 and may terminate at the trailing edge 34, as shown in FIG. 1. The pressure side outer weld rib 12 may have an outer side surface 88 that is aligned with the outer surface 48 of the generally elongated blade 30 forming the pressure side 20. The outer side surface 88 of the pressure side outer weld rib 12 may be aligned with an outer surface 90 of the pressure side weld member 17. The pressure side outer weld rib 12 may have any appropriate height and width. In at least one embodiment, as shown in FIG. 4, the pressure side outer weld rib 12 may have a height to width ratio of between about 2:1 and 1:2, and in at least one embodiment, may be about 1:1. The pressure side outer weld rib 12 may extend radially outward from the pressure side weld member 17 such that the pressure side outer weld rib 12 extends radially outward further than an outer surface of the suction side weld member 19.

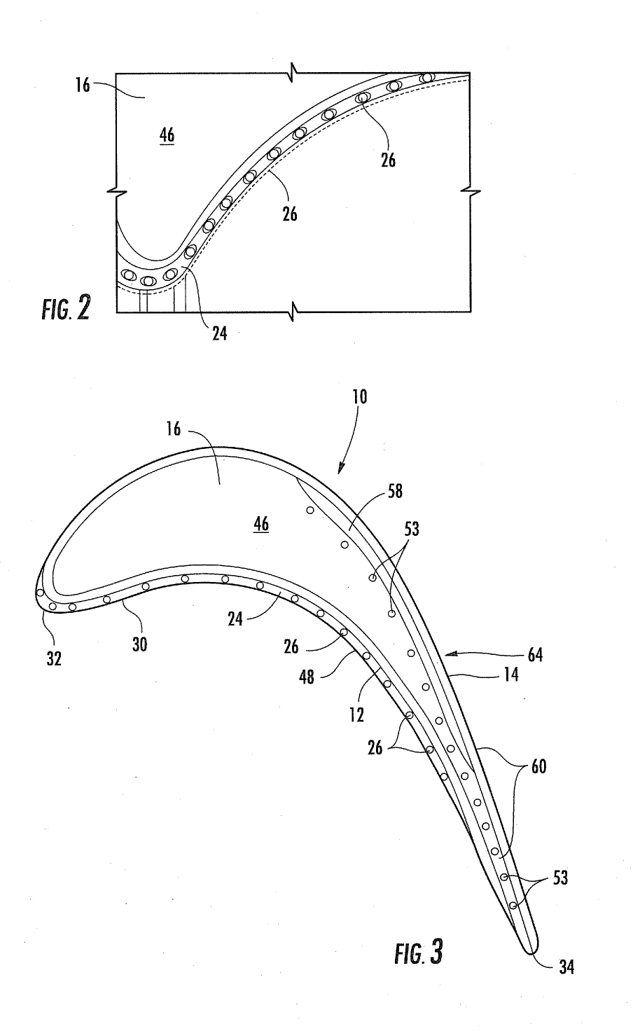

As shown in FIGS. 4, 11 and 12, the pressure side outer weld rib 12 may include a chamfered pressure side surface 24 positioned at an acute angle relative to an outer surface 48 of the generally elongated blade 30 forming the pressure side surface 20. An outermost corner 51 of the pressure side 20 may be positioned downstream from all other aspects of the pressure side surface 50 of the pressure side outer weld rib 12. In at least one embodiment, as shown in FIGS. 3 and 7, the chamfered pressure side surface 24 of the pressure side outer weld rib 12 may only extend for a portion of an entire length of the pressure side outer weld rib 12. Alternatively, the chamfered pressure side surface 24 may extend over an entire upstream side 50 of the pressure side outer weld rib 24.

One or more pressure side film cooling holes 26 may be positioned in the pressure side outer weld rib 12 with an outlet 28 in an outer surface 50 in the pressure side outer weld rib 12 and an inlet 52 that couples the pressure side film cooling hole 26 with the cavity 44 forming the internal cooling system 42. In one embodiment, as shown in FIGS. 3, 4 and 12, the outlet 28 of the pressure side film cooling hole 26 may be positioned in the chamfered pressure side surface 24 of the pressure side outer weld rib 12. The pressure side film cooling hole 26 in the pressure side outer weld rib 12 may be formed from a compound diffuser film cooling hole having at least one tapered section 56 with an increasing cross-sectional area.

As shown in FIGS. 4, 11 and 12, the turbine blade 18 may also include one or more suction side outer weld ribs 14 extending radially from an outer surface 92 for the tip 16. The suction side outer weld rib 14 may extend from, the trailing edge 34 to the leading edge 32 of the generally elongated blade 30 and terminate at the leading edge 32 and in communication with the pressure side outer weld rib 12. The suction side outer weld rib 14 may have an outer side surface 60 that is aligned with an outer surface 62 of the generally elongated blade 30 forming the suction side 22. The outer side surface 60 of the suction side outer weld rib 14 may be aligned with an outer surface 94 of the suction side weld member 19. The suction side outer weld rib 14 may have any appropriate height and width. In at least one embodiment, as shown in FIG. 4, the suction side outer weld rib 14 may have a height to width ratio of between about 2:1 and 1:2, and in at least one embodiment, may be about 1:1. The suction side outer weld rib 14 may extend radially outward from the suction side weld member 19 such that the suction side outer weld rib 14 extends radially outward further than an outer surface of the pressure side weld member 17.

The pressure side outer weld rib 12 may be formed from a first material, and the pressure side weld member 17, the suction side weld member 19 and the mid-chord member 21 may be formed from a second material that is different from the first material. The suction side outer weld rib 14 may be formed from a first material, and the pressure side weld member 17, the suction side weld member 19 and the mid-chord member 21 may be formed from a second material that is different from the first material. The pressure and suction side outer weld ribs 12, 14 may be formed from the same material, such as, but not limited to, IN625. The pressure side weld member 17, the suction side weld member 19 and the mid-chord member 21 may be formed from a material, such as, but not limited to, IN738.

One or more mid-chord film cooling holes 53 positioned in the mid-chord member 21 with an outlet 28 in an outer surface 64 in the mid-chord member 21, and an inlet 66 that couples the film cooling hole 26 with the cavity 44 forming the internal cooling system 42. As shown in FIGS. 5 and 6, the mid-chord film cooling hole 53 may be formed from a compound angle diffuser film cooling hole 80 having at least one tapered section 56 having an increasing cross-sectional area moving downstream.

As shown in FIGS. 4 and 12, the turbine blade 18 may include a thermal barrier coating 70 on the outer surfaces 48 and 62 forming the pressure and suction sides 20, 22, on outer surfaces 88, 72 of the pressure side outer weld rib 12, such as the chamfered pressure side surface 24 of the pressure side outer weld rib 12, on the outer surface 76 of the mid-chord member 21, on outer surfaces 60, 74 of the suction side outer weld ribs 14, on the outer surface 90 of the pressure side weld member 17, and on the outer surface 94 of the suction side weld member 19. The thermal barrier coating 70 may be formed from any appropriate material for protecting the turbine blade 18 from the hot temperatures found in the hot gas path of the turbine engine.

The pressure side film cooling holes 26 positioned in the pressure side ribs 12 or the mid-chord film cooling holes 53 may be formed from one or more diffusion cooling holes, as shown in FIGS. 5 and 6. The diffusion cooling holes may be formed from a compound angle diffuser film cooling hole 80 having at least one tapered section 56 with an increasing cross-sectional area. The tapered section 56 may extend only partially through the material forming the tip pressure side outer weld rib 12 or mid-chord member 21 and may be coupled to a consistent section 82. The compound angle diffuser film cooling hole 80 may be used for increased cooling coverage. For instance, as shown in FIG. 4, the mid-chord film cooling holes 53 positioned in the mid-chord member 21 may extend at an acute angle relative to the outer surface 46 of the mid-chord member 21. The pressure side film cooling holes 26 positioned in the pressure side outer weld rib 12 may extend radially outward through the pressure side outer weld rib 12. In addition, the pressure side film cooling hole 26 may extend into the pressure side outer weld rib 12 at an acute angle relative to the chamfered pressure side surface 24 of the pressure side outer weld rib 12. In another embodiment, the pressure side film cooling hole 26 may extend into the pressure side outer weld rib 12 generally orthogonal to the chamfered pressure side surface 24 of the pressure side outer weld rib 12.

As shown in FIG. 6, tapered section 56 of the compound angle diffuser film cooling hole 80 may have a generally oval cross-sectional shape, and the consistent section 82 may have a generally consistent diameter. As shown in FIGS. 5 and 6, the tapered section 56 may be formed from an outer wall surface 84 positioned at between about five degrees and about 15 degrees from an extension line 86 extending from the wall surface forming the consistent section 82. In one embodiment, the tapered section 56 may be formed from an outer wall surface 84 positioned at about ten degrees from the extension line 86 extending from the wall surface forming the consistent section 82.

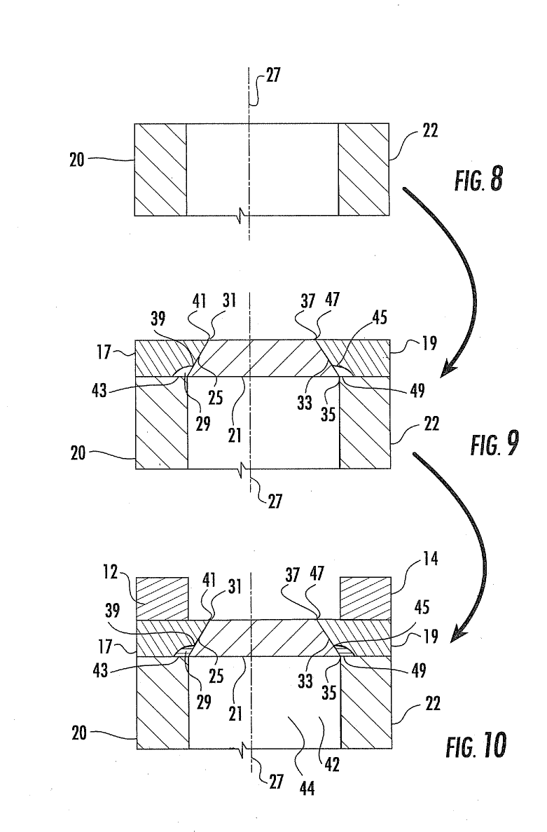

Turbine blades 18 incur tip wear during normal warm startup conditions. Turbine blades 18 may be repaired by reworking the tip. In particular, a method of repairing a turbine blade may include preparing the tip 16 of a blade 18 by removing existing tip structure on the generally elongated blade 30, as shown in FIG. 8. The tip 16 may be prepared by grinding the surface flat. The existing tip structure may be removed by grinding or other appropriate method. A pre-weld overage heat treatment may be applied before the mid-chord member 21 is placed on the tip 16. As shown in FIG. 9, a squealer tip 10 may be formed by positioning a mid-chord member 21 on the tip 16 covering the at least one cavity 44 forming the internal cooling system 42. The mid-chord member 21 may be held in place by welding the mid-chord member 21 on the blade tip 16 with materials such as, but not limited to, IN625 or Hastalloy W. The mid-chord member 21 may be configured as described herein. A pressure side weld member 17 may be formed on an upstream side of the mid-chord member 21 and a suction side weld member 19 on a downstream side of the mid-chord member 21 by welding. The pressure and suction side members 17, 19 may be formed as described herein. In at least one embodiment, the radially outer surfaces of the pressure side weld member 17 and suction side weld member 19 may be ground flush with a radially outer surface of the mid-chord member 21, as shown in FIG. 9.

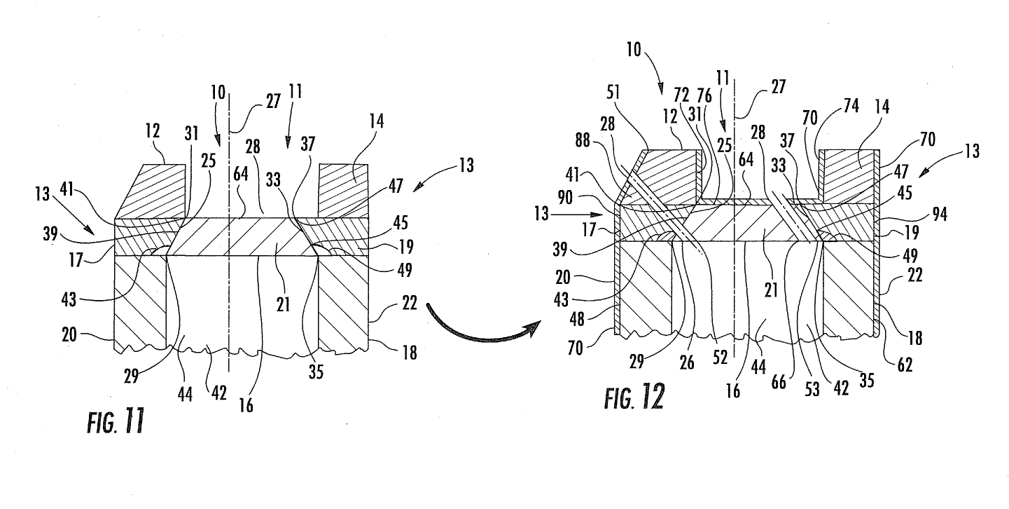

As shown in FIG. 10, a pressure side outer weld rib 12 may be formed extending radially outward from the pressure side weld member 17. The pressure side outer weld rib 12 may extend radially outward further than an outer surface of the suction side weld member 19. The pressure side outer weld rib 12 may be formed by a weld buildup of material, which may be, but is not limited to, IN625. A suction side outer weld rib 14 extending radially outward from the suction side weld member 19 may be formed. The suction side outer weld rib 14 may extend radially outward further than an outer surface of the pressure side weld member 17. The suction side outer weld rib 14 may be formed by a weld buildup of material, which may be, but is not limited to, IN625. As shown in FIG. 11, a chamfered pressure side surface 24 may be formed on the pressure side outer weld rib 12 such that an outermost corner 51 of the pressure side 20 is positioned downstream from all other aspects of the pressure side surface 50 of the pressure side outer weld rib 12.

The method may also include applying a thermal barrier coating 70, as shown in FIG. 12, on the outer surfaces forming pressure and suction sides 20, 22 of the generally elongated blade 30 and on outer surfaces of the pressure side weld member 17, the suction side weld member 19 and the mid-chord member 21. One or more pressure side film cooling holes 26 may be established in the pressure side outer weld rib 12 as described above through the thermal barrier coating 70 via drilling or other appropriate method. One or more mid-chord film cooling holes 53 may be established in the mid-chord member 21 as described above through the thermal barrier coating 70 via drilling or other appropriate method.

During use, cooling fluids are passed into the internal cooling system 42. The cooling fluids may be passed into the film cooling holes 26 in the tip 16 of the turbine blade 18. The cooling fluids may cool the tip 16 through convection and may cool aspects of the squealer tip 10 by being exhausted through the outlets 28. A portion of the cooling fluids may collect in the squealer tip downstream from the pressure side outer weld rib 12.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A turbine blade, comprising:
a generally elongated blade having a leading edge, a trailing edge, a squealer tip at a first end, a root coupled to the blade at a second end generally opposite the first end for supporting the blade and for coupling the blade to a disc, and an internal cooling system formed from at least one cavity positioned within the generally elongated blade;
wherein the squealer tip is formed from a first tip cap member and a second tip cap member;
wherein the second tip cap member is formed from a pressure side weld member and a suction side weld member and wherein the first tip cap member is formed from a mid-chord member positioned between the pressure and suction side weld members;
wherein the mid-chord member includes an upstream contact surface that is nonorthogonal and nonparallel with a longitudinal axis of the generally elongated blade such that an innermost corner of the upstream contact surface extends further upstream than an outermost corner of the upstream contact surface and includes a downstream contact surface that is nonorthogonal and nonparallel with the longitudinal axis of the generally elongated blade such that an innermost corner of the downstream contact surface extends further downstream than an outermost corner of the downstream contact surface;
wherein the pressure side weld member has a downstream contact surface that is nonorthogonal and nonparallel with the longitudinal axis of the generally elongated blade such that an outermost corner of downstream contact surface extends further downstream than an innermost corner of the downstream contact surface; and
wherein the suction side weld member has an upstream contact surface that is nonorthogonal and nonparallel with the longitudinal axis of the generally elongated blade such that an outermost corner of upstream contact surface extends further upstream than an innermost corner of the upstream contact surface.

2. The turbine blade of claim 1, wherein the mid-chord member is welded on innermost corners to the generally elongated blade.

3. The turbine blade of claim 1, further comprising a pressure side outer weld rib extending radially outward from the pressure side weld member such that the pressure side outer weld rib extends radially outward further than an outer surface of the suction side weld member.

4. The turbine blade of claim 3, wherein the pressure side outer weld rib has a chamfered pressure side surface such that an outermost corner of the pressure side is positioned downstream from all other aspects of the pressure side surface of the pressure side outer weld rib.

5. The turbine blade of claim 4, wherein the chamfered pressure side surface extends over an entire upstream side of the pressure side outer weld rib.

6. The turbine blade of claim 4, further comprising at least one pressure side film cooling hole positioned in the pressure side outer weld rib with an outlet in the chamfered pressure side surface in the pressure side outer weld rib and an inlet that couples the at least one pressure side film cooling hole with the at least one cavity forming the internal cooling system.

7. The turbine blade of claim 3, wherein the pressure side outer weld rib is formed from a first material, and the pressure side weld member, the suction side weld member and the mid-chord member are formed from a second material that is different from the first material.

8. The turbine blade of claim 1, further comprising at least one mid-chord film cooling hole positioned in the mid-chord member with an outlet in an outer surface of the mid-chord member and an inlet that couples the at least one mid-chord film cooling hole with the at least one cavity forming the internal cooling system.

9. The turbine blade of claim 1, further comprising a suction side outer weld rib extending radially outward from the suction side weld member such that the suction side outer weld rib extends radially outward further than an outer surface of the pressure side weld member.

10. The turbine blade of claim 9, wherein the suction side outer weld rib has an outer side surface that is aligned with an outer surface of the generally elongated blade forming a suction side.

11. The turbine blade of claim 9, wherein the suction side outer weld rib is formed from a first material, and the pressure side weld member, the suction side weld member and the mid-chord member are formed from a second material that is different from the first material.

12. The turbine blade of claim 9, wherein the pressure side outer weld rib has an outer side surface that is aligned with an outer surface of the generally elongated blade forming a pressure side.

13. The turbine blade of claim 1, further comprising a thermal barrier coating on the outer surfaces forming pressure and suction sides of the generally elongated blade and on outer surfaces of the pressure side weld member, the suction side weld member, and the mid-chord member.

14. A turbine blade, comprising:
a generally elongated blade having a leading edge, a trailing edge, a squealer tip at a first end, a root coupled to the blade at a second end generally opposite the first end for supporting the blade and for coupling the blade to a disc, and an internal cooling system formed from at least one cavity positioned within the generally elongated blade;
wherein the squealer tip is formed from a first tip cap member and a second tip cap member;
wherein the second tip cap member is formed from a pressure side weld member and a suction side weld member and wherein the first tip cap member is formed from a mid-chord member positioned between the pressure and suction side weld members;
wherein the mid-chord member includes an upstream contact surface that is nonorthogonal and nonparallel with a longitudinal axis of the generally elongated blade such that an innermost corner of the upstream contact surface extends further upstream than an outermost corner of the upstream contact surface and includes a downstream contact surface that is nonorthogonal and nonparallel with the longitudinal axis of the generally elongated blade such that an innermost corner of the downstream contact surface extends further downstream than an outermost corner of the downstream contact surface;
wherein the pressure side weld member has a downstream contact surface that is nonorthogonal and nonparallel with the longitudinal axis of the generally elongated blade such that an outermost corner of downstream contact surface extends further downstream than an innermost corner of the downstream contact surface;
wherein the suction side weld member has an upstream contact surface that is nonorthogonal and nonparallel with the longitudinal axis of the generally elongated blade such that an outermost corner of upstream contact surface extends further upstream than an innermost corner of the upstream contact surface;
a pressure side outer weld rib extending radially outward from the pressure side weld member such that the pressure side outer weld rib extends radially outward further than an outer surface of the suction side weld member;
at least one pressure side film cooling hole positioned in the pressure side outer weld rib with an outlet in an outer surface in the pressure side outer weld rib and an inlet that couples the at least one pressure side film cooling hole with the at least one cavity forming the internal cooling system;
at least one mid-chord film cooling hole positioned in the mid-chord member with an outlet in an outer surface of the mid-chord member and an inlet that couples the at least one mid-chord film cooling hole with the at least one cavity forming the internal cooling system;
a suction side outer weld rib extending radially outward from the suction side weld member such that the suction side outer weld rib extends radially outward further than an outer surface of the pressure side weld member;
wherein the pressure side outer weld rib is formed from a first material, and the pressure side weld member, the suction side weld member and the mid-chord member are formed from a second material that is different from the first material; and
wherein the suction side outer weld rib is formed from the first material, and the pressure side weld member, the suction side weld member and the mid-chord member are formed from the second material that is different from the first material.

15. The turbine blade of claim 14, wherein the mid-chord member is welded on innermost corners to the generally elongated blade.

16. The turbine blade of claim 15, wherein the pressure side outer weld rib has a chamfered pressure side surface such that an outermost corner of the pressure side is positioned downstream from all other aspects of the pressure side surface of the pressure side outer weld rib.

17. The turbine blade of claim 16, wherein the chamfered pressure side surface extends over an entire upstream side of the pressure side outer weld rib.

18. The turbine blade of claim 14, further comprising a thermal barrier coating on the outer surfaces forming pressure and suction sides of the generally elongated blade and on outer surfaces of the pressure side weld member, the pressure side outer weld rib, the suction side weld member, the suction side outer weld rib and the mid-chord member.

19. A method of repairing a turbine blade, comprising:
preparing a tip of the blade by removing existing tip structure on a generally elongated blade having a leading edge, a trailing edge, the tip at a first end, a root coupled to the blade at a second end generally opposite the first end for supporting the blade and for coupling the blade to a disc, and an internal cooling system formed from at least one cavity positioned within the generally elongated blade;
forming a squealer tip by positioning a mid-chord member on the tip covering the at least one cavity forming the internal cooling system, wherein the mid-chord member includes a tapered upstream contact surface that is nonorthogonal and nonparallel with a longitudinal axis of the generally elongated blade such that an innermost corner of the upstream contact surface extends further upstream than an outermost corner of the upstream contact surface and includes a tapered downstream contact surface that is nonorthogonal and nonparallel with the longitudinal axis of the generally elongated blade such that an innermost corner of the downstream contact surface extends further downstream than an outermost corner of the downstream contact surface;
forming a pressure side weld member on an upstream side of the mid-chord member and a suction side weld member on a downstream side of the mid-chord member by welding, wherein the pressure side weld member has a downstream contact surface that is nonorthogonal and nonparallel with the longitudinal axis of the generally elongated blade such that an outermost corner of downstream contact surface extends further downstream than an innermost corner of the downstream contact surface, and wherein the suction side weld member has an upstream contact surface that is nonorthogonal and nonparallel with the longitudinal axis of the generally elongated blade such that an outermost corner of upstream contact surface extends further upstream than an innermost corner of the upstream contact surface;
forming a pressure side outer weld rib extending radially outward from the pressure side weld member such that the pressure side outer weld rib extends radially outward further than an outer surface of the suction side weld member; and
forming a suction side outer weld rib extending radially outward from the suction side weld member such that the suction side outer weld rib extends radially outward further than an outer surface of the pressure side weld member;
forming a chamfered pressure side surface on the pressure side outer weld rib such that an outermost corner of the pressure side is positioned downstream from all other aspects of the pressure side surface of the pressure side outer weld rib.

20. The method of claim 19, further comprising
applying a thermal barrier coating on the outer surfaces forming pressure and suction sides of the generally elongated blade and on outer surfaces of the pressure side weld member, the suction side weld member and the mid-chord member,
establishing at least one pressure side film cooling hole positioned in the pressure side outer weld rib with an outlet in an outer surface in the pressure side outer weld rib, through the thermal barrier coating, and an inlet that couples the at least one pressure side film cooling hole with the at least one cavity forming the internal cooling system; and
establishing at least one mid-chord film cooling hole positioned in the mid-chord member with an outlet in an outer surface of the mid-chord member, through the thermal barrier coating, and an inlet that couples the at least one mid-chord film cooling hole with the at least one cavity forming the internal cooling system.
